(19) United States
(12) Patent Application Publication
(10) Pub. No.: US 2006/0162205 A1
(43) Pub. Date: Jul. 27, 2006

(54) Reusable laminate display

(76) Inventors: Garry T. Cooper, Midhurst (CA); Ian S. Erskine, Camrose (CA)

Correspondence Address: HARNESS, DICKEY & PIERCE, P.L.C., P.O. BOX 828, BLOOMFIELD HILLS, MI, 48303, US

(21) Appl. No.: 11/094,829

(22) Filed: Mar. 30, 2005

(30) Foreign Application Priority Data
Jan. 26, 2005 (CA) 2,494,445

(51) Int. Cl. G09F 7/12

(52) U.S. Cl. 40/594

(57) ABSTRACT

A reusable laminate display, having a display layer, and a reinforcing layer having opposite front and rear faces. The display layer is affixed to the front face. The display layer and reinforcing layer together form a panel. The panel has a front panel face corresponding to the front face of the reinforcing layer and a rear panel face opposite the front panel face. A repositionable second adhesive is applied to one of the front panel face and the rear panel face.

### FIELD OF THE INVENTION

This invention relates to reusable displays.

### BACKGROUND OF THE INVENTION

Businesses use various displays and signage to draw attention to their locations and to notify prospective customers of promotions being featured. A popular form of display involves displaying graphic elements on an existing smooth surface, such as the window of a building or vehicle. Another popular display surface of this type, particularly for car dealerships, is the body of a vehicle.

This type of display can be a valuable marketing tool because unlike many other advertising media, this type of display reaches customers when they are close to the business. In contrast, radio, television and newspapers are relatively expensive and generally reach a target audience when they are far removed from the business.

There are currently a few methods used to display graphic elements on smooth surfaces.

A common method of applying this type of display is to paint the display directly onto the surface. This method is suitable for the interior or exterior surfaces of windows, where the display will be protected. This method suffers from a number of disadvantages. Painting the display elements requires a fair degree of artistic skill, which contributes significantly to the cost of this type of display. A disadvantage of this method is that the display is produced on site without the benefit of any mass production. Once applied, the display cannot be repositioned or changed. Changing the display requires the destruction or removal of all or part of the display and the application of a new display. This is particularly inconvenient in relation to specific promotions, which businesses typically wish to change regularly to reflect changes in market conditions. Further, removal of the paint is usually time consuming, which increases the cost of this type of display. Removal of the paint can damage the surface on which the paint is applied; for example, glass is easily scratched by the scraping of paint applied thereto. The paint itself can also temporarily or permanently tarnish the surface. Finally, these types of paints have a tendency to fade or discolour, thereby limiting the useful life of a display of this type.

Another common method of applying displays to smooth surfaces is using thin vinyl display elements, coated on one side with a strong adhesive. Due to the strength of the adhesive and the relatively stretchy and easily torn nature of vinyl sheeting, these display elements are difficult to remove once applied. In attempting to remove these elements, they typically tear or deform. Further, if accidentally crumpled, these elements tend to self-adhere so as to become useless. These elements also typically suffer from bubbling and wrinkling, when applied to a surface. Because once properly applied it is virtually impossible to reposition a display element of this type, it suffers from many of the drawbacks of the painted display described above. Specifically, applying the display requires some skill, while removal is time consuming, both of which increase the cost. An additional consequence to the time requirement and effort required is that the display often remains in place long after the relevant promotional period or season has ended. Further, even after removal, the adhesive may leave residue on the surface to which it was applied. For many businesses, the cost and effort associated with applying this type of display renders it unsuitable for advertising short term promotions.

It is also known to apply a static charge to a thin display element made from a material such as vinyl; the display element can then be adhered to certain display surfaces, such as glass, as a result of the static charge. This type of display element can be repositioned very few times before it loses its static charge and becomes unable to adhere to a surface.

It is an object of the invention to obviate or mitigate at least one of the above-mentioned disadvantages of the prior art.

### SUMMARY OF THE INVENTION

Accordingly, in one of its aspects the present invention comprises a reusable laminate display, comprising:
a display layer;
a reinforcing layer having opposite front and rear faces, the display layer being affixed to the front face, the display layer and reinforcing layer together forming a panel;
the panel having a front panel face corresponding to the front face of the reinforcing layer and a rear panel face opposite the front panel face;
a repositionable second adhesive applied to one of the front panel face and the rear panel face.

### DESCRIPTION OF THE DRAWINGS

Embodiments of the present invention will be described with reference to the accompanying drawings, wherein like reference numerals denote like parts, and in which:

FIG. 1 is an exploded perspective view of the reusable laminate display according to the present invention.

FIG. 2 is an exploded perspective view of the reusable laminate display according to the present invention cut into the shape of a graphic element.

FIG. 3 is a cross-sectional view of an embodiment of the reusable laminate display according to the present invention, wherein the second adhesive is applied to the front panel face.

FIG. 4 is a cross-sectional view of an embodiment of the reusable laminate display according to the present invention, wherein the second adhesive is applied to the rear panel face.

FIG. 5 is a perspective view of the reusable laminate display according to the present invention cut into the shape of a graphic element.

FIG. 6 is a perspective view of the reusable laminate display graphic element of FIG. 5, wherein the removable backing is partially removed.

FIG. 7 is an exploded perspective view of a window display formed using reusable laminate display graphic elements according to the present invention.

FIG. 8 is a cross-sectional view of an embodiment of the reusable laminate display according to the present invention, wherein a further display layer is affixed to the rear face of the reinforcing layer.

FIG. 9 is a plan view of multiple display panels of the reusable laminate display according to the present invention, formed on a single larger reinforcing layer.

FIG. 10 is a partially exploded perspective view of multiple reusable laminate displays according to the present invention layered to form a complex display.

FIG. 11 is an exploded perspective view of a car window display formed of the multiple reusable laminate displays of FIG. 10.

FIG. 12 is a plan view of a two-sided reusable laminate display according to the present invention.

FIG. 13 is an exploded perspective view of a two-sided reusable laminate display according to the present invention.

### DESCRIPTION OF PREFERRED EMBODIMENTS

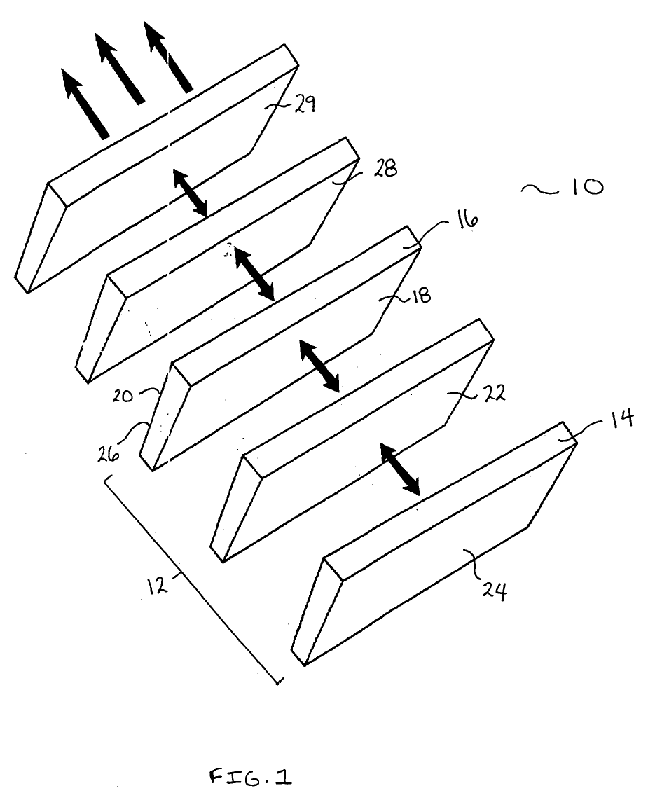

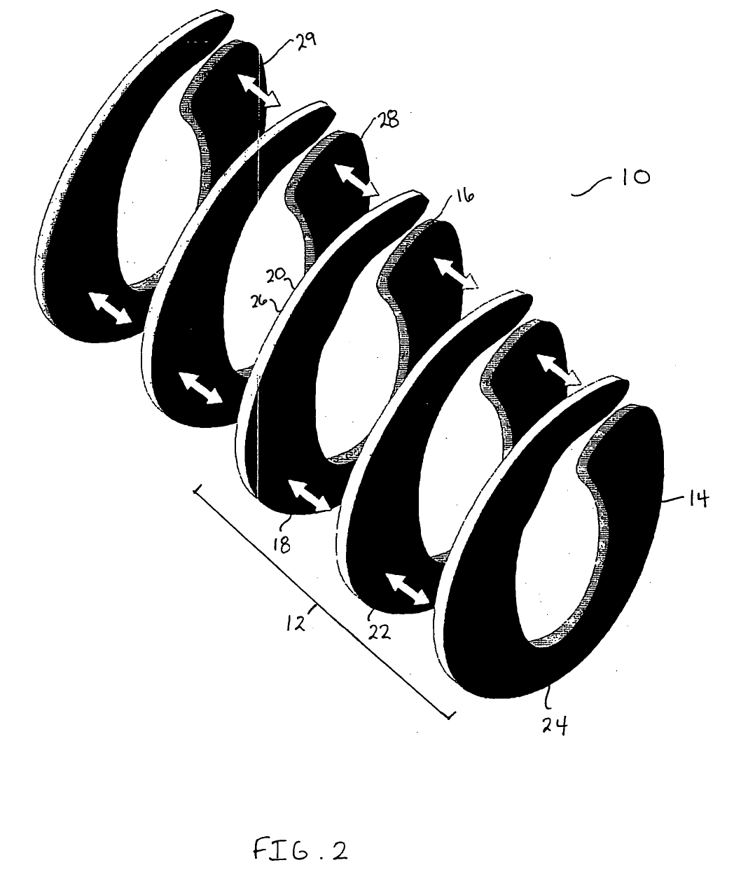

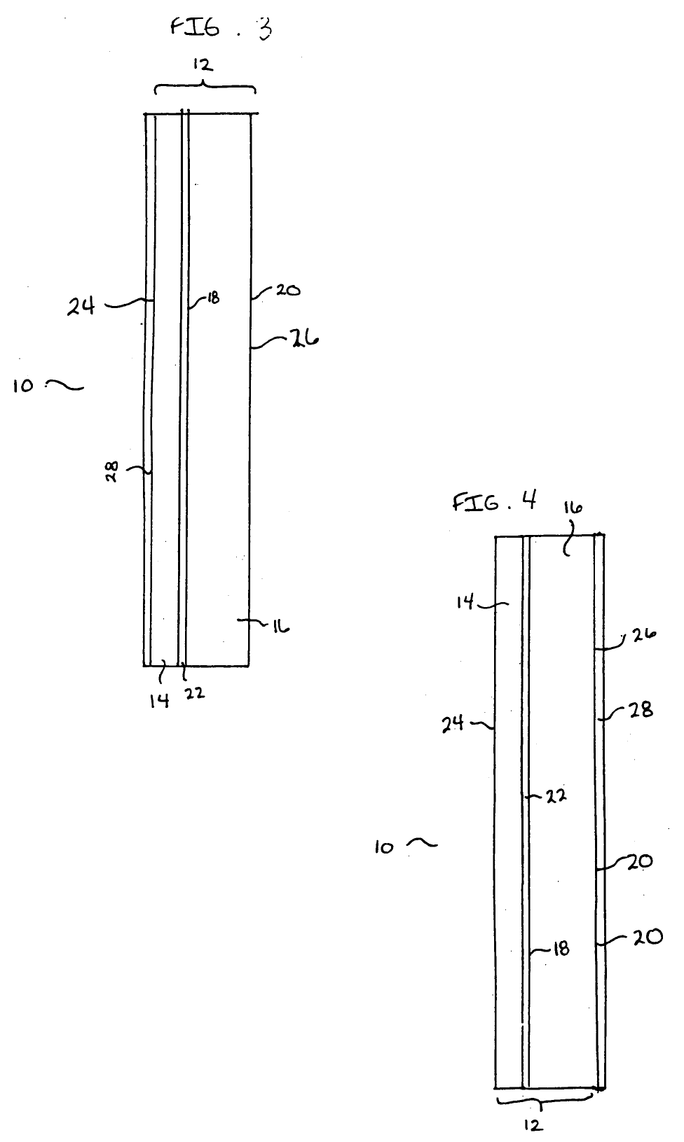

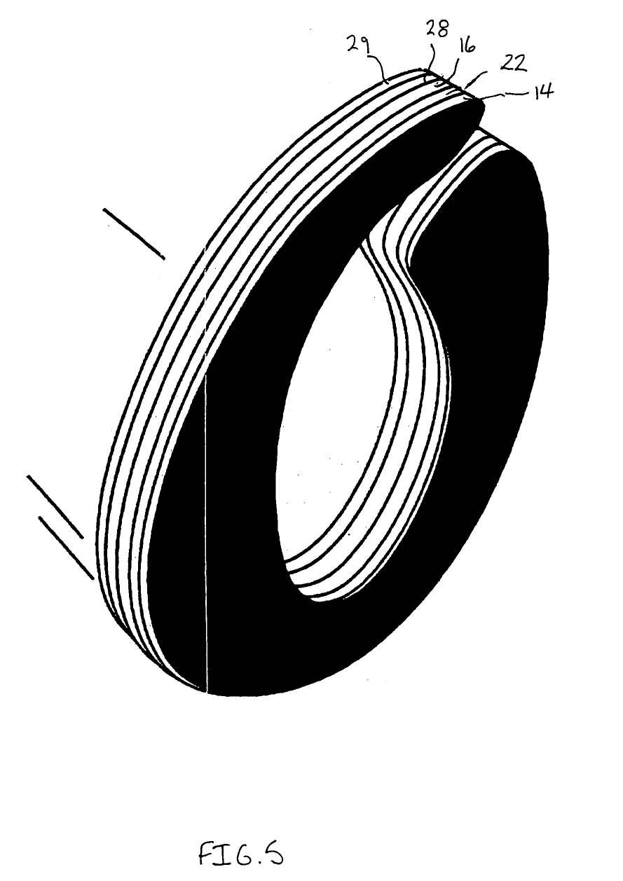

Referring now to FIGS. 1, 2, 3, and 4 re-usable laminate display 10 is formed from a panel 12 that includes a display layer 14 and a reinforcing layer 16. The laminate display 10 may be a sheet as shown in FIG. 1, or may be cut into a graphic element as shown in FIG. 2. The reinforcing layer 16 has a front face 18 and a rear face 20. The display layer 14 is affixed to the front face 18, preferably by a first adhesive 22. The panel 12 has a front panel face 24 (corresponding to the front face 18) and a rear panel face 26. A repositionable second adhesive 28 is applied to one of the front panel face 24 and the rear panel face 26. In FIG. 3, the second adhesive 28 is applied to the front panel face 24, while in FIG. 4, the second adhesive 28 is applied to the rear panel face 26. Preferably, as shown in FIGS. 1 and 2, the laminate display 10 is manufactured with a “peel off” removable backing layer 29 adhered to the second adhesive 28.

Preferably, the second adhesive 28 is applied to cover the entire surface area of the panel face to which it is applied, however, as will be apparent to a person skilled in the art, the second adhesive 28 may be applied to only portions of the panel face, suitably being applied over sufficient surface area to ensure adequate adhesion of the associated panel to a smooth surface.

In this context, repositionable means that the adhesive:
can be reused in that the panel 12 can be removed and adhered to a clean, smooth surface multiple times without significant decrease in the “pull off force”; and
it is a light tack adhesive in that the strength of the adhesive is such that the force required to remove the panel 12 from a clean smooth surface is such that the panel 12 is unlikely to tear.

The repositionable second adhesive 28 provides particular benefits in regard to the problem of self-sticking. Specifically, the light tack nature of the adhesive means that self-stuck parts can be readily separated, and the reusable nature of the adhesive means that the associated panel can be applied to another surface.

Preferably, the second adhesive 28 is substantially clear. This is particularly preferred where the second adhesive 28 is applied on the display layer 14. Preferably, the second adhesive 28 is substantially non-staining, non-bleeding, and does not leave a residue on the surface to which it is adhered. The repositionable adhesive is long-lasting, retaining its repositionable properties for months and, preferably, years with normal use. Preferably, the second adhesive 28 causes minimal wrinkling of the display layer 14 and the reinforcing layer 16. The second adhesive 28 may be applied in multiple layers.

A suitable adhesive is 3M™ ReMount™ Repositionable Adhesive 6091.

The reinforcing layer 16 provides strength to the panel 12, which minimizes the likelihood of it tearing. The reinforcing layer 16 is suitably pliable in order to facilitate its application to a contoured surface, such as a car windshield. Preferably, the reinforcing layer 16 is stable in that it maintains its integrity during prolonged exposure to the elements and/or changes in temperature.

The material used to form the reinforcing layer 16 is not particularly restricted and is within the purview of persons skilled in the art, as long as it imparts the desired properties to the reinforcing layer 16. The reinforcing layer 16 is preferably formed of vinyl, polyethylene, and nylon or a combination thereof. Less preferably, various rubber, polyester, and even some plastic materials may be used to form the reinforcing layer 16. The reinforcing layer 16 may be formed of a single materials or a combination of materials (including a material having a reinforcing structure such as an embedded mesh). A suitable material will have suitable properties as described above i.e. provides strength to the panel, which minimizes likelihood of it tearing and is suitably pliable.

In the case of a vinyl reinforcing layer 16, the vinyl preferably has a thickness between about 15 and about 30 mil, and more preferably about 20 mil.

A particularly preferred reinforcing layer 16 is formed of “scrim vinyl”, which comprises a polyester scrim embedded in vinyl. Scrim vinyl is a product typically used as banner material.

The reinforcing layer 16 may be formed of a plurality of layers of material fused together.

The first adhesive 22 is preferably stronger than the second adhesive 28. The first adhesive 22 is preferably a permanent adhesive. In this context, permanent means that the adhesive has sufficient strength that affixed parts will not separate during normal handling. As will be apparent to a person skilled in the art, the first adhesive 22 may be applied to the entire contact surface between the display layer 14 and the face to which it is affixed or a portion thereof. Preferably, the first adhesive 22 is applied to the entire contact surface area. The first adhesive 22 may be applied in multiple layers.

Suitable first adhesives 22 have properties similar to those used by a number of pressure sensitive vinyl manufacturers such as 3M, Oracal, or Emery.

In an alternate embodiment, the display layer 14 may be affixed to the front face 18 by fusing the two surfaces together, such as by, for example, compressing a pre-laminate under heat and pressure to form the panel 12.

The display layer 14 is a relatively thin layer of material. The display layer 14 will typically be brightly coloured to improve the look of graphic elements. Most preferably the display layer 14 is formed of a fluorescent material, which augments the impact the display has on passers-by.

The display layer 14 is preferably formed of a material selected from the group comprising vinyl and rubber, or a combination thereof. Most preferably the display layer 14 is formed of vinyl. The vinyl is preferably a PVC-type vinyl typically used in the signage industry and manufactured by companies such as 3M, Oracal and Emery.

When a vinyl display layer is used, the vinyl is preferably between about 2 mil and 7 mil thick, more preferably between about 4 and 6 mil thick.

The display layer 14 may be formed of a plurality of layers of material fused together.

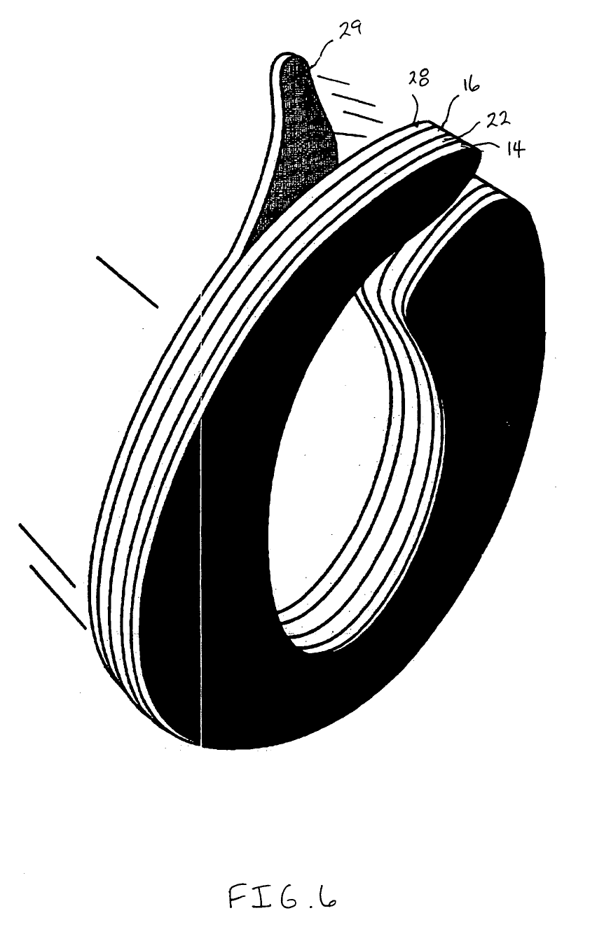

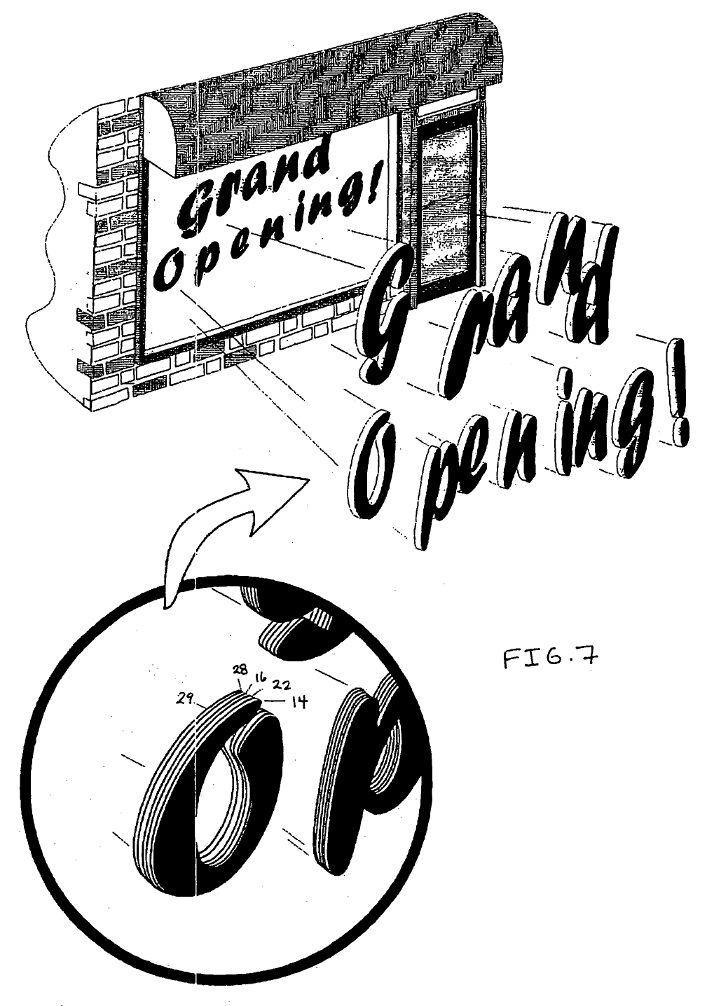

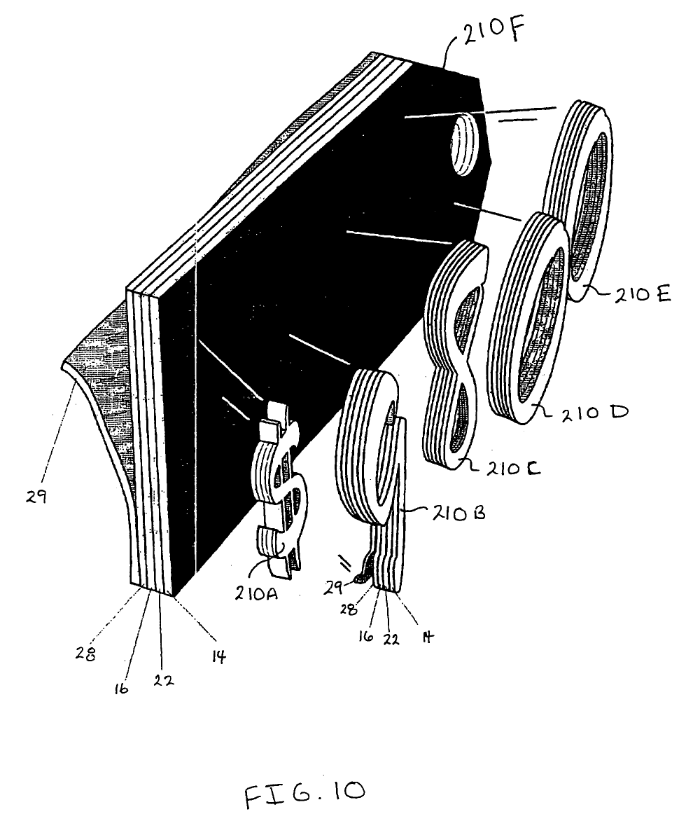

With reference to FIGS. 5, 6, and 7, the laminate display 10 will typically be cut into the shape of a graphic element. As shown in FIG. 6, prior to adhesion of the laminate display 10 to a surface, such as a window, backing layer 29 will be removed from the laminate display 10. (As will be apparent to a person skilled in the art, as second adhesive 28 is repositionable, the backing layer 29 may be re-adhered to the second adhesive 28 a number of times, in order to protect it when the laminate display 10 is not in use.) One or more laminate displays of the present invention, formed into graphic elements, can be affixed to a surface, such as a window, to form a complex display, as shown in FIG. 10.

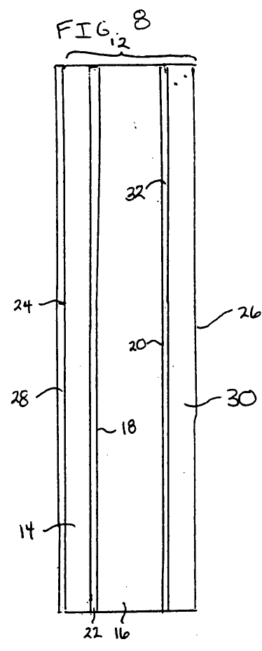

As shown in FIG. 8, the panel 12 can further include a further display layer 30 affixed such as by a third adhesive 32 to the rear face 20 of the reinforcing layer 16. The third adhesive 32 may be the same or different than the first adhesive 22, although it is preferably the same adhesive.

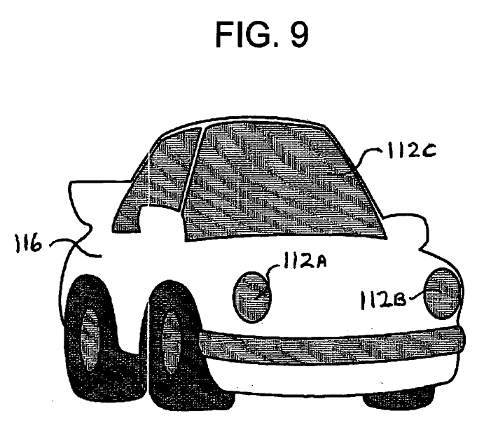

The size of the display layer 14 and the reinforcing layer 16 are not particularly restricted and can be made to suit the needs of persons skilled in the art. Further, and referring to FIG. 9, multiple panels 112 of the present invention may be formed on a single larger reinforcing layer 116. As shown in FIG. 9, the reinforcing layer 116 is cut into the shape of an automobile. Panels 112A, 112B, and 112C, of various shapes corresponding to the features of the automobile, such as headlights and a windshield are formed on the reinforcing layer 116 using correspondingly shaped pieces of display layer 114 affixed to the front face of reinforcing layer 116. As will be apparent to a person skilled in the art, a similar visual effect could be achieved by forming a complex display by affixing multiple panels (i.e. 112A, 112B, and 112C) on to a larger laminate display (i.e. 110) shaped as an automobile.

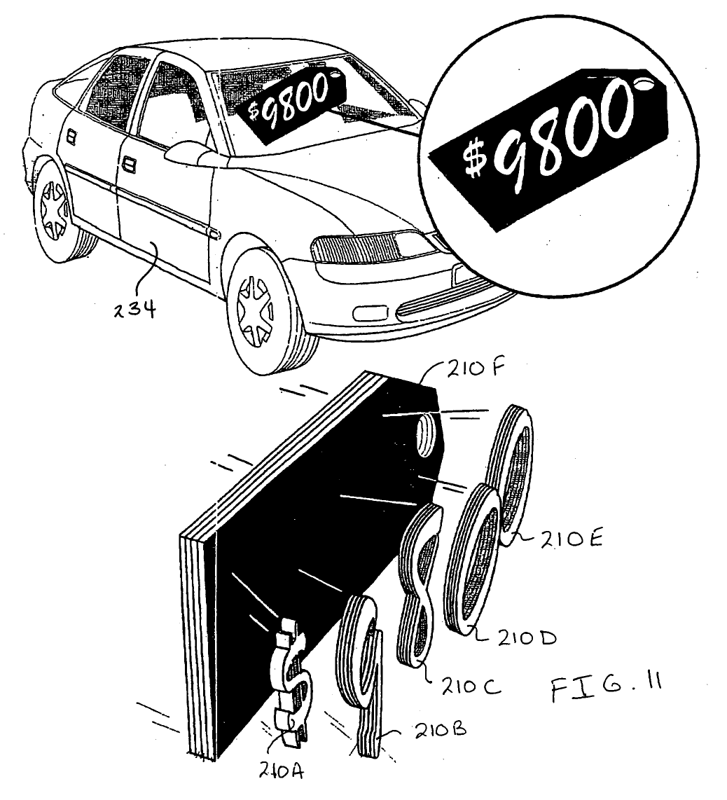

Displays of the present invention may be affixed to other displays or “layered” in order to create a more complex display. Referring to FIGS. 10 and 11, a reusable and easily varied pricing display is formed by affixing various laminate display elements 210A, 210B, 210C, 210D, and 210E, cut into the shape of various graphics to a price tag shaped laminate display 210F. All laminate displays (210A, 210B, 210C, 210D, 210E, and 210F) can have contrasting colourful display layers, thereby further augmenting the impact of the overall display. Further, due to the repositionable nature of the second adhesive, the various elements that make up the complex display can be easily varied.

Once an item (such as a car 334 in FIG. 11) is sold, the “price tag” can be transferred to another car. This is a huge saving in time and cost as compared to previous “painted on” signage which had to be scraped off and a graphic artist retained to paint a new sign on the other item. This is also a significant advantage over the previous adhesive vinyl signage which also had to be scraped off and discarded and a skilled applicator retained to re-apply new material on the other item. Also, the signage can be temporarily removed, for example where the car 334 is to be taken for a “test drive”. Further, the price itself can be readily changed.

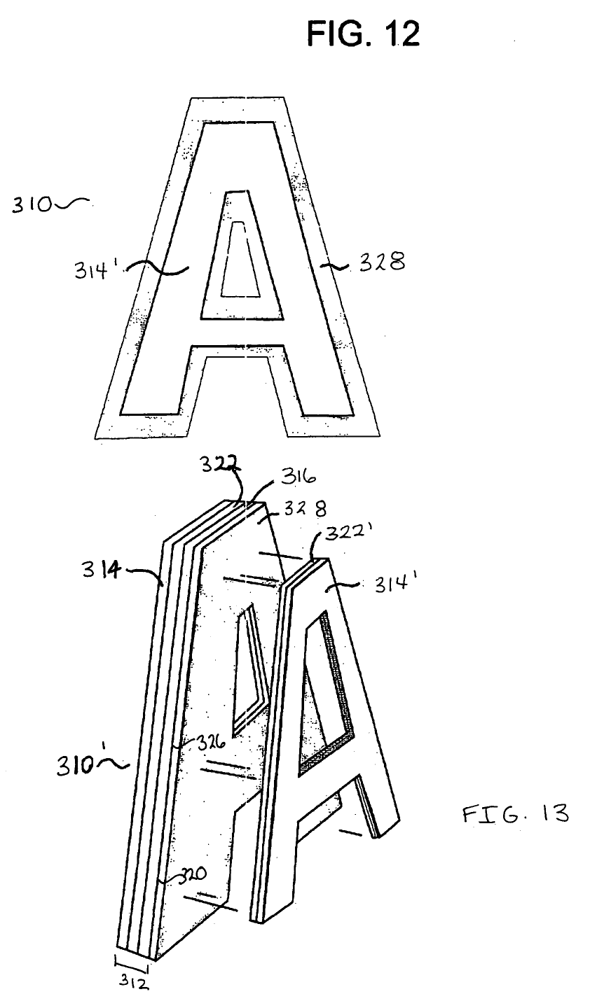

Referring to FIGS. 12 and 13, a two-sided laminate display can be formed. This form of display is particularly suitable where it is desirable for a reusable laminate display to be located on the inside of the window with a display surface visible on both an exterior side of the window and an interior side of the window. A two-sided reusable laminate display 310′ is formed from a reusable laminate display according to the invention, having (as described above) a display layer 314 affixed to the front face 318 of a panel 312 having a front panel face 324 and a rear panel face 326, the reusable laminate display 326 having the repositionable second adhesive 328 applied to the rear panel face 326. A further display layer 314′ is affixed to the rear panel face 326. The further display layer 314′ is smaller than the rear panel face 326, leaving an exposed portion of the rear face panel 326 having the second repositionable adhesive 328 applied thereto, which provides for adhesion of the two-sided reusable laminate display 310′ to a surface, such as a window (not shown). In the embodiment shown, the further display layer 314′ is affixed to the repositionable adhesive 328 by means of a third adhesive 322′, which is preferably a permanent adhesive and is preferably the same as the first adhesive 322. As will be apparent to a person skilled in the art, alternatively, the further display layer 314′ could be applied directly to the repositionable adhesive 328, or if the repositionable adhesive did not cover the entire back panel 326, it could be adhered (either partially or completely) directly to rear panel face 326. The display layer of this two-sided reusable laminate display can also be affixed to a further reinforcing layer and this further reinforcing layer can be adhered to the rear panel face to affix the display layer thereto.

It is intended that the above description be interpreted in an illustrative rather than a restrictive sense. Variations to the features described above may be apparent to those skilled in such structures without departing from the spirit and scope of the invention as defined by the claims set out below.

1. A reusable laminate display, comprising:
a display layer;
a reinforcing layer having opposite front and rear faces, the display layer being affixed to the front face, the display layer and reinforcing layer together forming a panel;
the panel having a front panel face corresponding to the front face of the reinforcing layer and a rear panel face opposite the front panel face;
a repositionable second adhesive applied to one of the front panel face and the rear panel face.

2. The reusable laminate display of claim 1, further comprising a removable backing layer adhered to the repositionable second adhesive.

3. The reusable laminate display of claim 1, wherein the display layer is fused to the front face.

4. The reusable laminate display of claim 1, wherein the display layer is affixed to the front face by a first adhesive.

5. The reusable laminate display of claim 4, wherein the first adhesive is a permanent adhesive.

6. The reusable laminate display of claim 1, wherein the second adhesive is clear.

7. The reusable laminate display of claim 1, wherein the reinforcing layer is formed of a material selected from the group consisting of vinyl, polyethylene, nylon, rubber, polyester, and plastic, and combinations thereof.

8. The reusable laminate display of claim 7, wherein the reinforcing layer is formed of vinyl.

9. The reusable laminate display of claim 8, wherein the reinforcing layer has a thickness of between about 15 and about 30 mil.

10. The reusable laminate display of claim 8, wherein the reinforcing layer is formed of scrim vinyl.

11. The reusable laminate display of claim 7, wherein the reinforcing layer is formed of a plurality of layers of material.

12. The reusable laminate display of claim 1, wherein the display layer is formed of a material selected from the group consisting of vinyl, rubber, and combinations thereof.

13. The reusable laminate display of claim 12, wherein the display layer is formed of vinyl.

14. The reusable laminate display of claim 13, wherein the display layer is formed of vinyl have a thickness between about 2 and about 7 mil.

15. The reusable laminate display of claim 12, wherein the display layer is formed of a plurality of layers of material.

16. The reusable laminate display of claim 1, wherein the display layer is coloured.

17. The reusable laminate display of claim 16, wherein the display layer is fluorescent coloured.

18. The reusable laminate display of claim 1, wherein the display layer is contiguous with the reinforcing layer over the entire face to which it is affixed.

19. The reusable laminate display of claim 1, wherein a plurality of display layers are affixed to the reinforcing sheet.

20. The reusable laminate display of claim 1, wherein the panel further includes a further display layer affixed by a third adhesive to the rear face of the reinforcing layer.

21. A two-sided reusable laminate display comprising a reusable laminate display according to claim 1, wherein the repositionable second adhesive is applied to the rear panel face and a further display layer is affixed to the rear panel face, wherein the further display is smaller than the rear panel face, leaving an exposed portion of the rear panel face having the second adhesive applied thereto for adhesion to a surface.

22. The two-sided reusable laminate display of claim 21, wherein the further display layer is affixed to the rear panel face by a permanent adhesive.

23. The two-sided reusable laminate display of claim 21 wherein the further display layer is affixed to the rear panel face by a repositionable adhesive.

24. The two-sided reusable laminate display of claim 21 wherein the further display layer is affixed to a further reinforcing layer and the further reinforcing layer is adhered to the rear panel face to affix the further display layer thereto.
